(19) United States
(12) Patent Application Publication
(10) Pub. No.: US 2007/0076973 A1
(43) Pub. Date: Apr. 5, 2007

(54) Method and apparatus for detecting and deblocking variable-size grid artifacts in coded video

(76) Inventors: Walid Ali, Chandler, AZ (US); Mahesh M. Subedar, Tempe, AZ (US)

Correspondence Address: Buckley, Maschoff & Talwalkar LLC, Five Elm Street, New Canaan, CT, 06840, US

(21) Appl. No.: 11/239,946

(22) Filed: Sep. 30, 2005

(51) Int. Cl. G06K 9/40

(52) U.S. Cl. 382/268

(57) ABSTRACT

A method may include receiving image information. Blockiness artifacts are detected in the image information, wherein the detected blockiness artifacts are associated with different grid sizes.

### BACKGROUND

Compression of video streams may result in blockiness (a checker-board pattern) that reduces the overall picture quality. These are generally referred to as Moving Picture Experts Group (MPEG) artifacts, such as the International Organization for Standardization (ISO)/International Engineering Consortium (IEC) Motion Picture Experts Group (MPEG) standard entitled “Advanced Video Coding (Part 10)” (2004). As other examples, image information may be processed in accordance with ISO/IEC document number 14496 entitled “MPEG-4 Information Technology-Coding of Audio-Visual Objects” (2001) or the MPEG2 protocol as defined by ISO/IEC document number 13818-1 entitled “Information Technology—Generic Coding of Moving Pictures and Associated Audio Information” (2000).

In some common cases, the grid size of the checker-board pattern is uniform all throughout the video image, such as 8×8 pixels (8:8), 12×12 pixels (12:12), 8×4 pixels (8:4), etc. output on video screens. In other cases, variable block sizes may exist in the same image. This may be, for instance, the result of content-sensitive MPEG encoders (e.g., coding highly detailed or moving parts in an image using more bits or smaller block sizes).

### BRIEF DESCRIPTION OF THE DRAWINGS

FIG. 1 illustrates a method for detecting and correcting for non-uniform blockiness in coded video according to some embodiments.

FIGS. 2 and 3 illustrate a more detailed method for detecting and correcting for non-uniform blockiness according to some embodiments.

FIGS. 4 and 5 illustrate a method for determining vector multiplication of array positions according to some embodiments.

FIG. 6 illustrates a system for detecting and correcting for non-uniform blockiness in coded video according to some embodiments according to some embodiments.

FIG. 7 is a schematic of a video screen having a plurality of vector points.

FIG. 8 illustrates system FIG. 6 with the use of an integrated circuit and a circuit board according to some embodiments.

FIG. 9 illustrates a method for detecting blockiness according to some embodiments.

### DETAILED DESCRIPTION

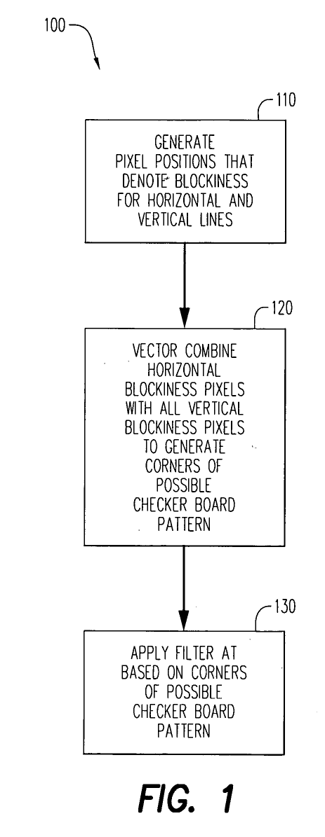

FIG. 1 is a high-level method 100 for detecting a checker board (“blockiness”) pattern in decoded video streams. The video streams might be decoded, for example, in accordance “Advanced Video Coding (Part 10)” as mentioned previously. Generally, in method 100, because various comparisons that detect potential blockiness artifacts are made on a pixel by pixel level, a plurality of variable size blocks can be detected in the same video picture.

In 110, a change of intensity of a primary color (“color”) of a video picture between two proximate pixels (denoted for ease of illustration as a first pixel and a second pixel), is tested against a defined intensity threshold on first axis, such as a horizontal axis. If the change of intensity of the color from the first pixel to the second pixel is above the intensity threshold, the second pixel is denoted a blockiness pixel. The second pixel is then compared to a third pixel, and so on. This comparison is completed on both a first (such as horizontal) and a second (vertical) axis of the video picture, and also for all three primary colors RBG (standard Red, Blue, Green) or alternative representations, such as YUV (a color coding schemes with magnitudes having separate codes for the luminance, blue color level and red color level). Any pixel for any color (or luminance, or other measurement of color or picture intensity) with the requisite threshold change can denote a blockiness pixel. The first and second axis pixels are stored in separate arrays. 110 then advances to 120.

In 120, all of the blockiness pixel locations in the memory for the first axis (horizontal) pixels are vector combined with all of the blockiness pixel locations for all the second axis (vertical) pixels. This generates vector (comer) positions for various comers of intersection for potential blockiness artifacts. For instance, if the horizontal blockiness pixels detected in 110 are 3 and 5, and the vertical blockiness pixels detected in 110 are pixels 9 and 16, the vector positions of pixels are (3,9); (3,16); (5,9); and (5,16). 120 then advances to 130.

In 130, a smoothing filter is applied in the neighborhood of the vector positions generated in 120. Typically, these smoothing filters regulate the change intensity of one or more colors in the neighborhood the vector positions, thereby reducing the blockiness associated with the video code.

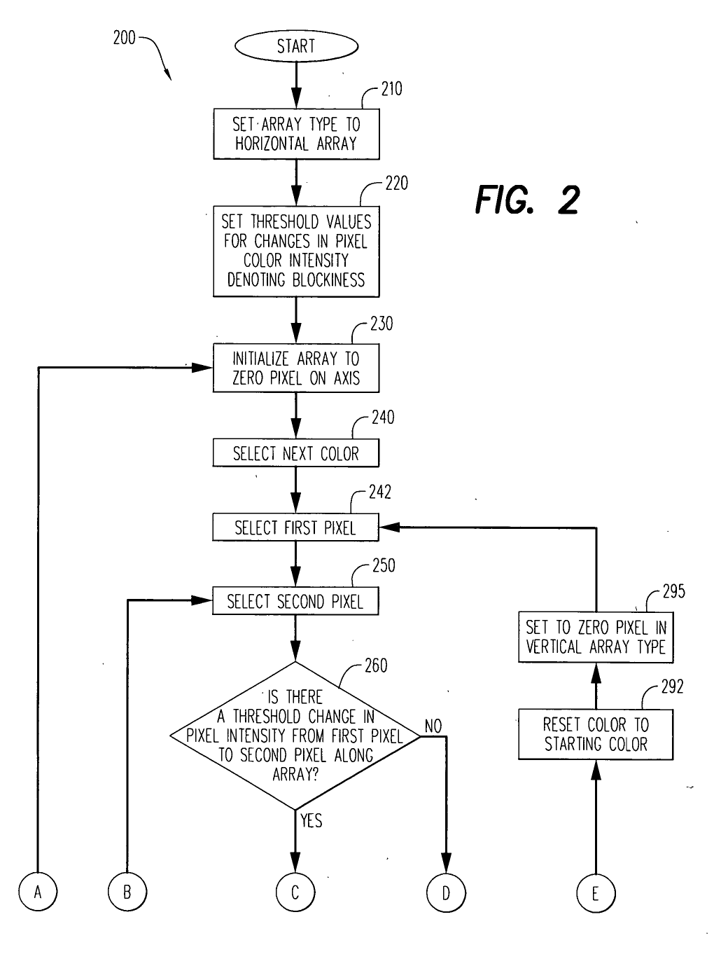

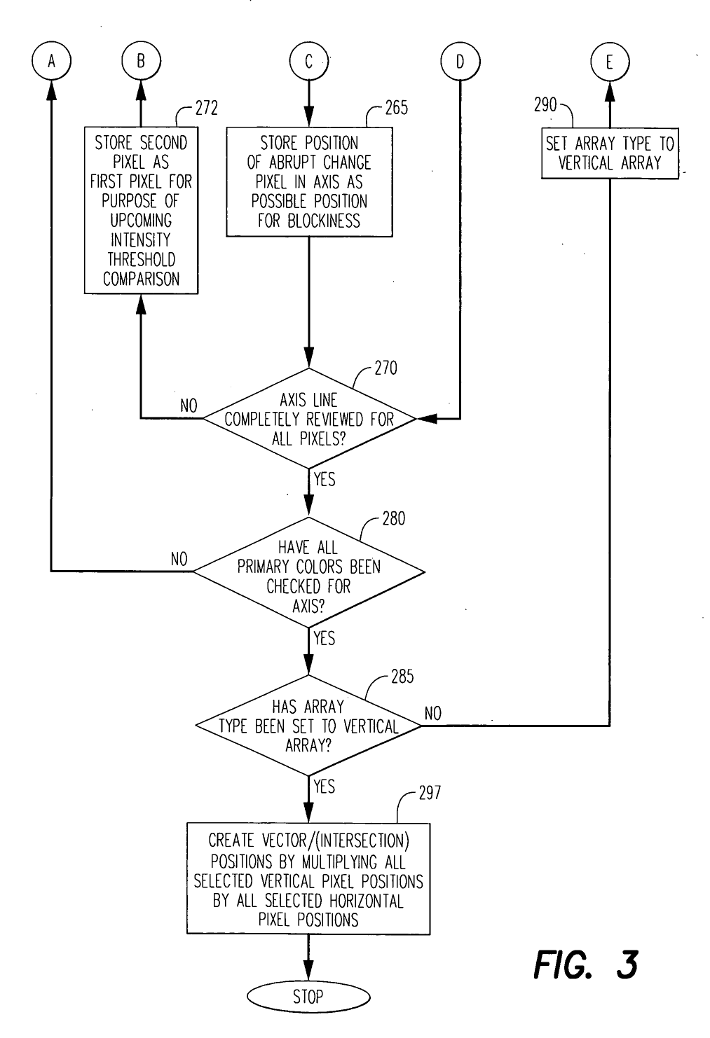

FIGS. 2 and 3 illustrate a method 200 for detecting a smoothing for blockiness artifacts in a coded video according to one embodiment. After starting, in 210, a first array type to be set is for a horizontal array. The horizontal array can be the very first horizontal array of a video screen, or some other horizontal array of the video screen. 210 then advances to 220.

In 220, a threshold value or values are set for detecting a possible blockiness pixel by selecting an intensity threshold value of a change of intensity from pixel to proximate pixel for at leas one of the three primary colors of the video display. In a further embodiment, all three colors have different intensity threshold values. The intensity threshold value can be pre-programmed or programmed by a user. If a complete lack of a given color intensity is denoted a value of “zero,” and the maximum allowable intensity is “255,” exemplary values for the threshold intensity could be a change of 38-50, i.e., a change of 15% to 20% of intensity between pixel to pixel. However, other values are within the scope of the present description. 220 advances to 230.

In 230, the pixel count on the selected axis (in this case, horizontal) is set to zero. 230 advances to 240.

In 240, the next color of the three primary colors that comprise the video is selected, (for instance, from one of Red, Green, or Blue for the RGB set of colors), as appropriate to the coded video. For ease of illustration, the RGB color set will be described in relation to the selected colors. As this is the first time 240 has been executed in this description, the first color is selected in 240. 240 advances to 242.

In 242, a first pixel at the beginning of the axis is selected. 242 advances to 250.

In 250, a next pixel is selected/incremented to along the selected axis. This will typically be the adjacent pixel along the selected axis. 250 advances to 260.

In 260, it is determined whether there is a difference of intensity between the first pixel and the selected pixel for the selected color that is greater than the intensity threshold determined in 220. If no, 260 advances to 270. If yes, 260 advances to 265. In one embodiment, if one of the selected color has had a difference of intensity, that 260 advances to 265 without a further check for that axis. If another embodiment, all of the colors are individually tested.

In 265, the position of the second pixel is stored in a memory for the selected axis as a potential position for a blockiness pixel. The blockiness pixels for the horizontal axis are stored in a first memory location, and the blockiness pixels for the horizontal axis are stored in a separate memory location, for use in later vector multiplication. 265 advances to 270.

In 270, it is determined if all pixel transitions for the selected axis line have been tested against the intensity threshold. If no, 270 advances to 272. If yes, 270 advances to 280.

In 272, for the purpose of continued comparison of intensity of color change between proximate pixels versus the change of intensity threshold, the second pixel position and color intensity is stored as the first pixel position and color intensity. Proximate can be generally defined as pixels as either next to one another or having some other defined relationship (such as two distant from each other, three distant from each other, and so on).

In one embodiment, the proximate pixel is the next pixel in an array. 272 loops back to 250, above.

In 280, it is determined if the array type (horizontal or vertical) has been tested for intensity changes for all of the primary colors. If all of the primary colors intensity thresholds for the array type have not been tested, then 280 loops back to 230. If all of the primary colors intensity thresholds have been tested for the array type, 280 advances to 285.

In 285, it is determined whether the selected array type is the vertical array type. If it is, then method 200 stops. If not, 285 advances to 297.

In 290, the selected array type is changed to the vertical type. 290 advances to 292.

In 292, the selected color is reset to the first color of the color set (for instance, Red of RGB primary color set). 292 advances to 295.

In 295, the first pixel is set to a null pixel in the vertical array. 295 loops back to 242.

In 297, vector positions are created by multiplying the arrays generated in 265 for both the horizontal and vertical axis. Note that 297 is analogous to 120 of method 100.

For instance, if the two arrays detected and generated in 265 are [1, 10, 15, 20] and [1, 10, 15, 20] the corner vectors, and hence the grid size, detected are: [1, 1]; [1, 10]; [1,15]; [1,20]; [10,1]; [10,10]; [10,15]; [10,20]; [15,1]; [15,10]; [15,15]; [15,20]; [20,1]; [20,10]; [20,15]; [20;20].

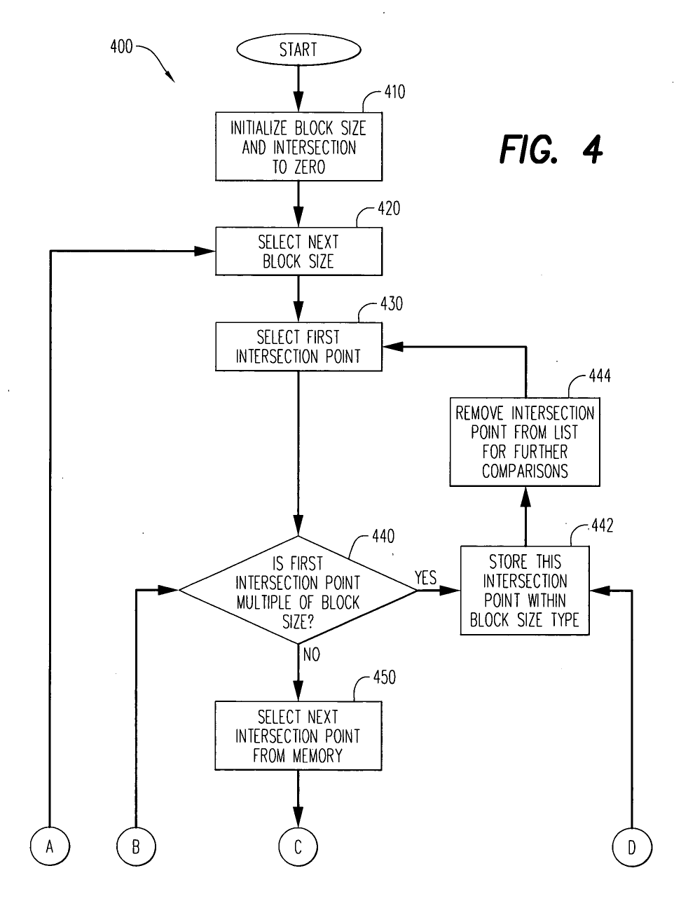

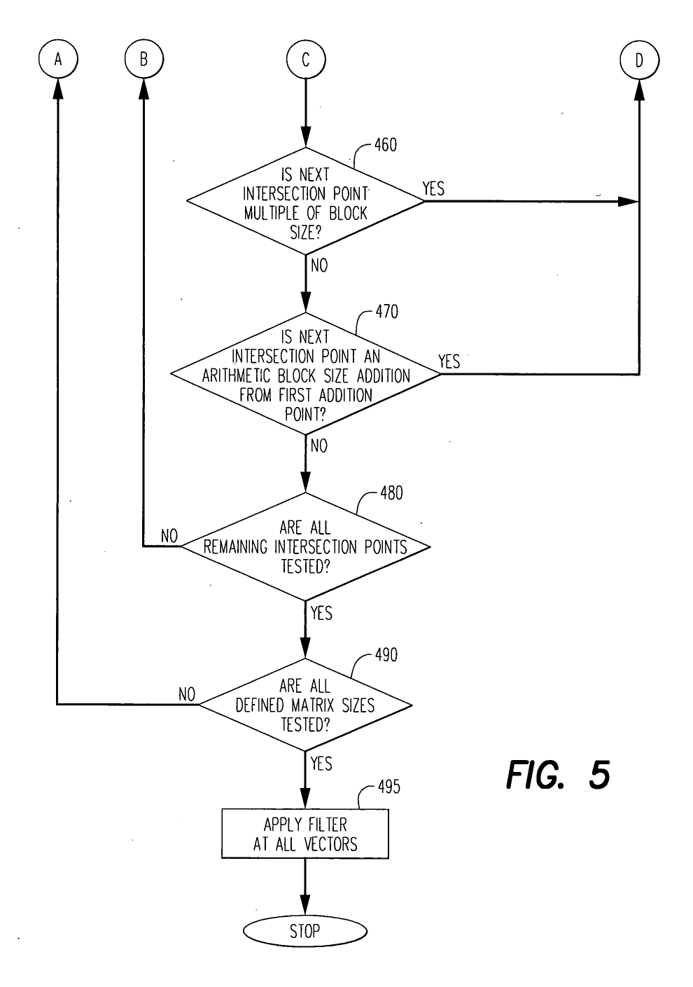

FIGS. 4 and 5 illustrate, in one embodiment, a method 400 that further details 297 for calculating potential vector positions for various blocking sizes from the horizontal and vertical scalar pixel values, and then further illustrates applying a smoothing filter at the potential vector positions.

In 410, both the block size and the first intersection point are set to zero. 410 advances to 420.

In 420, a next block size is selected. This could be, for instance, for the first block size, a 4×4 (4:4) block size, which would be followed as 420 is re-executed, a 4×8 (4:8) block size, an (8:4) block size, a (6:8) block size, and so on. In any event, 420 advances to 430.

In 430, a first vector position (intersection point) is then selected from the vectors generated in 297. Note that this first vector is a remaining vector position from a list generated in 297, as will be detailed below. 430 advances to 440.

In 440, it is determined whether the selected vector is a multiple of the block size selected in 420. For instance, if the block size is (4:4), it is determined whether the selected vector position is a multiple of (4:4) block. In other words, for a (4:4) block, it is determined whether the selected vector position is at (4,4); (8,8); (12,12) and so on. If yes, 440 advances to 442. If no, 440 advances to 450.

In 442, the selected vector is then stored with a memory for the appropriate block size. For instance, if (8,8) is determined to be a multiple of (4:4), then a memory for the (4:4) array has a (8,8) vector position value assigned to it. Furthermore, a count is incremented for that block size. 442 advances to 444. In one embodiment, the count is used by an operator to adjust the differential threshold.

In 444, the selected vector position is then removed from the list of vectors. 444 then loops back to 430.

In 450, the next vector position point is then selected from memory. For instance, if the first vector was (6,12); and (6,12) is determined not to be a multiple of the selected block size (4:4); then the next vector in the list, perhaps (10, 16) is selected. 450 then advances to 460.

In 460, it is determined whether this next vector position is a multiple of the selected block size. For instance, 460 might determine if exemplary vector position (10,16) is a multiple of block size (4:4). In any event, if this next selection point is a multiple, 460 loops back to 442. If not, 460 advances to 470.

In 470, the first intersection vector position and a next intersection vector position are compared to each other to see if one is an arithmetic block size addition from the other. If so, both of the intersections are to be stored with the selected block size, and 470 loops back to 442 for both intersection vector positions.

For instance, an exemplary first vector of (6, 12) is not a multiple of (4:4), but (6, 12) and (10, 16) are (4:4) distance from each other, so they would both still be associated with the (4:4) block.

In 480, it is determined whether all remaining intersection vectors have been tested against the selected block size. If no, 480 loops back to 440. If yes, 480 advances to 490.

In 490, it is determined whether all of the block size sizes have been tested. If no, 490 loops back to 420. If yes, apply filter in 495 and then method 400 stops.

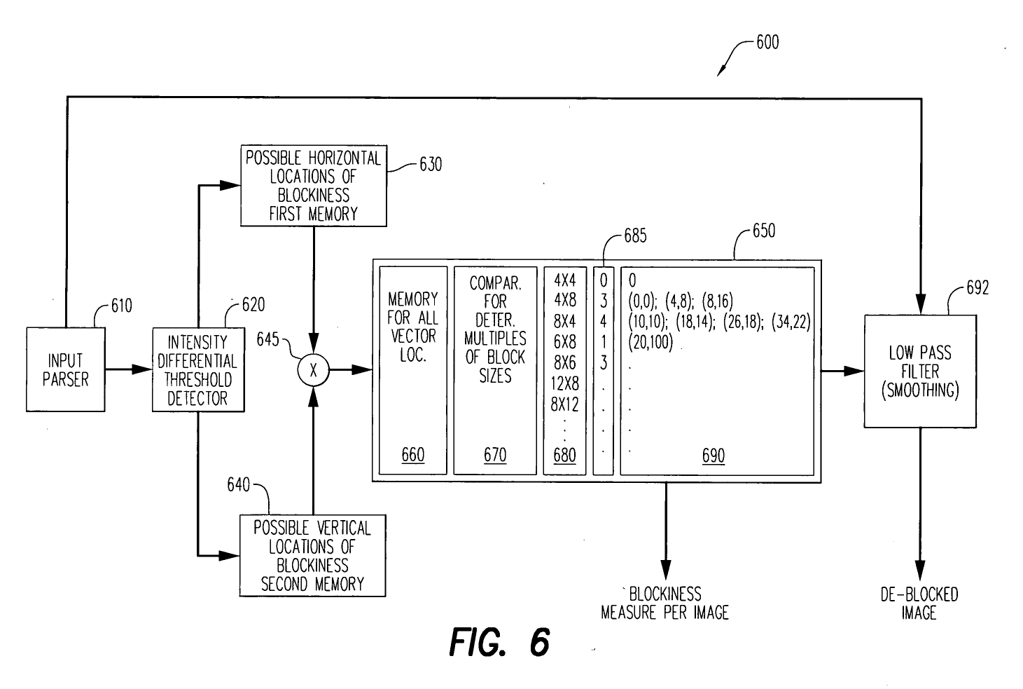

FIG. 6 illustrates a video deblocker (“deblocker”) 600 for deblocking video. A coded video having a plurality of pixels is received by an input parser 610. After a decoding of the input is performed by input parser 610, the pixels received by an intensity differential threshold detector (“threshold detector”) 620 and a low pass filter 692.

Threshold detector 620 is coupled to a first memory 630 and a second memory 640. First and second memories are used to store pixel positions for changes in intensity as determined by threshold detector 620 for the horizontal and vertical axis, respectively. First and second memories 640, 650 are coupled to a vector position multiplier 645. Vector position multiplier 645 is coupled to a blockiness detector 650. Blockiness detector 650 generates data of a number of vector positions per block size per image. Blockiness detector 650 is also coupled to the low pass filter 692. Low pass filter 692 then generates a deblocked image as a combination of the decoded video from the input parser 610 and an output from blockiness detector 650. According to some embodiments, a viewer might adjust operation of low pass filter 692.

Blockiness detector 650 has a memory 660 for vector locations, a comparator 670 for determining block sizes, a memory array 680 of various block sizes, a memory count 685 for the number of determinations of counts for different sizes, and a memory 690 for storing the various vector locations for the various block sizes. Note that memory count 685 and memory 690 might be used with, for example, a hash table.

In one embodiment, in video deblocker 600, 210 through 250 of method 200 are performed by input message parser 610. 260 is performed by threshold detector 620. 265 is performed in block 610, and the pixel location is placed in memory 630 or 640, as appropriate. 270, 272, 280, 285 and 290, 292 and 294 are then again performed by input message parser 610. 297 is performed by vector position multiplier 645, and the results are input into memory 660 of blockiness detector 660.

In another embodiment, method 400 is performed by blockiness detector 650 and low pass filter 692 with the employment of comparator 670, memory array 680, memory count 685, memory 690, and low pass filter 692.

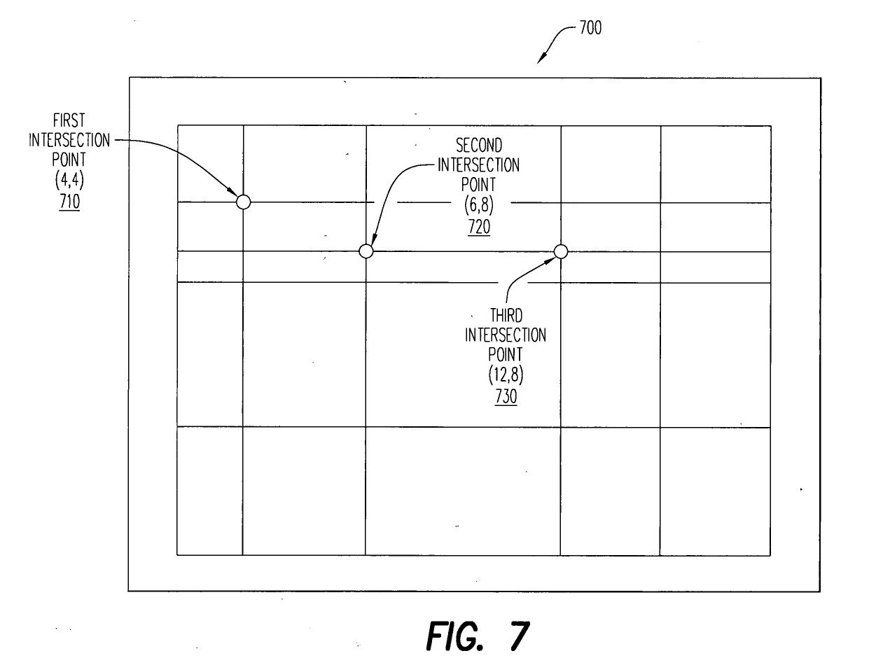

FIG. 7 illustrates an exemplary embodiment of a video display (“display”) 700 that has detected various block sizes and intersections points illuminated upon it. In display 700, a first intersection point 710 is located at intersection point (4,4), a second intersection point 720 is located at intersection point (6,8), and a third intersection point 730 is located at (12,8). In other embodiments, another intersection point may be (4,8). Each of these intersection points will have the low pass smoothing filter 692 applied to them and other proximate pixels. Through application of low pass filter 692, the blockiness of images is reduced.

In a further embodiment, low pass filter 692 is applied to multiples of the first, second and third intersection points 710, 720 and 730. For instance, low pass filter 692 is applied at an intersection points (8,8) and (12,12), as a function of the first intersection point (4,4) 710 and low pass filter 692 is further applied to intersection points (12, 16) and (18,24) as a function of the second intersection points 720, and so on.

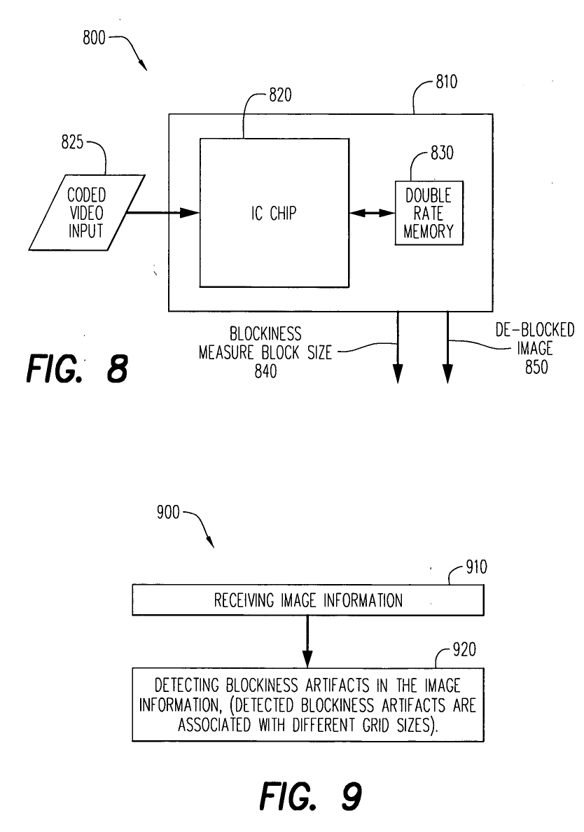

FIG. 8 illustrates a system according to some embodiments. System 800 may execute methods 200 and 400. System 800 includes a motherboard 810, a video input 820, an integrated circuit (“IC chip”) 825, and a memory 830. System 800 may comprise components of a desktop computing platform, and memory 830 may comprise any type of memory for storing data, such as a Single Data Rate Random Access Memory, a Double Data Rate Random Access Memory, or a Programmable Read Only Memory.

IC chip 825 receives coded video input 820 and performs various methods 200 and 400. In FIG. 8, information that is stored is stored in memory 830, and both a measurements of blockiness measure per block size per image 840 and the deblocked image itself are output by motherboard 810, perhaps through digital I/O ports (not illustrated).

FIG. 9 illustrates method 900. In 910, image information is received by system 800. Then, in 920, blockiness artifacts are detected in the image information. The detected blockiness artifacts are associated with different grid sizes.

The several embodiments described herein are solely for the purpose of illustration. Some embodiments may include any currently or hereafter-known versions of the elements described herein. Therefore, persons in the art will recognize from this description that other embodiments may be practiced with various modifications and alterations.

What is claimed is:

1. A method, comprising:
receiving image information; and
detecting blockiness artifacts in the image information, wherein the detected blockiness artifacts are associated with different grid sizes.

2. The method of claim 1, further comprising:
correcting the detected blockiness artifacts; and
providing corrected image information.

3. The method of claim 1, wherein the received image information comprises a set of pixels, and said detecting comprises:
selecting a first pixel along a first axis;
selecting a second pixel along the first axis;
determining if an intensity of a color change from the first pixel to the second pixel exceeds a threshold;
storing a first position of the intensity of the color change if the intensity of the color change from the first pixel to the second pixel exceeds the threshold;
selecting a first pixel along a second axis;
selecting a second pixel along the second axis;
determining if an intensity of a color change from the first pixel to the second pixel exceeds a threshold;
storing a second position of the intensity of the color change if the intensity of the color change from the first pixel to the second pixel exceeds the threshold; and
defining a vector position as a function of the first position and the second position.

4. The method of claim 3, further comprising filtering the video output at the vector position defined first position and the second position.

5. The method of claim 3, wherein the first pixel has a position value and a color intensity value.

6. The method of claim 3, further comprising selecting a second color of a color set; and
determining if an intensity of a color change of the second color of a color set from the first pixel to the second pixel exceeds a threshold; and
storing a position of the intensity of the color change.

7. The method of claim 3, wherein the first pixel and second pixel are adjacent pixels.

8. The method of claim 4, wherein filtering further comprises applying a smoothing filter.

9. The method of claim 3, further comprising:
multiplying the first position and the second position by an integer value to generate a second vector position; and
filtering the second vector position.

10. The method of claim 3, further comprising:
defining a default block size;
comparing the vector position to the default block size; and
storing said vector position with the default block size.

11. The method of claim 3, wherein the color is selected from a plurality of colors, and the plurality of colors consist of red, green and blue.

12. The method of claim 3, wherein the color has a minimum intensity and a maximum intensity, and the threshold is set at a minimum of a change of approximately 15% of intensity from the first pixel to the second pixel.

13. The method of claim 3, wherein the threshold is set by a user.

14. A system, comprising:
a threshold detector to detect whether a color change from a first pixel to a second pixel exceeds a threshold for both a first axis and a second axis;
a first memory to store a first pixel position of the first axis if the color change from the first pixel to the second pixel on the first axis exceeds the threshold;
a second memory to store a second pixel position of the second axis if the color change from the first pixel to the second pixel on the second axis exceeds the threshold;
a vector generator to generate a vector position as a function of the first pixel position and the second pixel position; and
a filter to filter the vector position.

15. The system of claim 14, wherein the first and second memory are logical memories and integral within one memory chip.

16. The system of claim 14, further comprising a fourth memory to store a pre-selected block size to be compared to the vector position.

17. The system of claim 16, further comprising a comparator to compare the vector position to the pre-selected block size.

18. The system of claim 14, further comprising a memory to store a count associated with the vector position.

19. The system of claim 14, wherein the filter comprises a low-pass filter.

20. The system of claim 14, further comprising:
a printed circuit board;
an input port to receive a first pixel and a second pixel;
a double rate memory coupled to the circuit board; and
an integrated circuit having the threshold detector, the integrated circuit coupled to the circuit board.

21. A method, comprising:
detecting blockiness artifacts in the image information, wherein the detected blockiness artifacts are associated with different grid sizes; and
correcting at least one of the blockiness artifacts that are associated with different grid sizes.
